(19) United States
(12) Patent Application Publication
(10) Pub. No.: US 2005/0136849 A1
(43) Pub. Date: Jun. 23, 2005

(54) Method and apparatus for enhancing the call access rate in a communication system

(75) Inventor: Hyoung Chang Kang, Seoul (KR)

Correspondence Address: JONATHAN Y. KANG, ESQ.;LEE, HONG, DEGERMAN, KANG & SCHMADEKA, P.C., 801 S. Figueroa Street, 14th Floor, Los Angeles, CA, 90017, US

(73) Assignee: LG Electronics Inc.

(21) Appl. No.: 11/016,450

(22) Filed: Dec. 17, 2004

(30) Foreign Application Priority Data
Dec. 17, 2003 (KR) P2003-92482

(51) Int. Cl. H04B 1/40

(52) U.S. Cl. 455/84; 375/295

(57) ABSTRACT

A method and apparatus for enhancing the call access rate in a communication system generates a pilot signal from a FPGA (Field Programmable Gate Array) integrated with a multi-carrier digital transceiver, produces a phase-equalized beacon signal from said generated pilot signal, and multiplies the phase-equalized beacon signal by a predetermined oscillation frequency generated by a NCO (Numerical Control Oscillator). The NCO output is summed up with a pre-distorted user data output signal. The summed up signal is rearranged for synchronization and power amplification.

### CROSS-REFERENCE TO RELATED APPLICATIONS

Pursuant to 35 U.S.C. § 119(a), this application claims the benefit of earlier filing date and right of priority to Korean Patent Application No. P2003-92482, filed on Dec. 17, 2003, the contents of which is hereby incorporated by reference in its entirety.

### BACKGROUND OF THE INVENTION

1. Field of the Invention

The present invention relates generally to the field of telecommunications, and more particularly to a method and apparatus for enhancing the call access rate in a communication system.

2. Description of the Related Art

Cellular call handoff refers to the process of transferring a call between base stations. Handoff occurs when a call has to be handed off from one cell to another as the mobile telephone user moves between cells. A mobile service switching center automatically creates and interprets the necessary command signals to control mobile telephones via associated base stations. The mobile service switching center switches channels to maintain voice transmission as the mobile telephone user moves from one coverage area to another.

A typical handoff scenario may involve a first base station communicating with a mobile telephone. Upon indication that the signal strength of the mobile telephone is decreasing, a handoff command is sent by the first base station to the mobile telephone. The mobile telephone tunes to a new radio carrier and begins to transmit a control tone indicating that it is operating on a particular channel. The mobile service switching center senses that the mobile telephone is ready to transmit/receive on that channel and switches the call to a second base station to avoid interruption in voice communications.

In a traditional “hard” handoff, the connection to the current cell is broken, and then connection to a new cell is made. This is generally known as “break-before-make” handoff. In a spread spectrum communication system, such as CDMA (Code Division Multiple Access) where the same frequency band is shared between all the cells, it is possible to make the connection to the new cell before leaving the current cell. This is known as “make-before-break” or “soft” handoff. Soft handoff requires less power, which leads to reduced interference and increased capacity.

Hard handoffs utilize heterogeneous frequency assignments (FAs) which may lead to a reduction in the call access rate. Call access rate reduction is conventionally handled by adding pilot beacon functionality to the base station. A CDMA base station traditionally includes base station transceiver(s) and a base station controller. The base station transceivers convert audio signals from the system into RF (Radio Frequency) signals which are communicated to mobile telephones moving through the coverage area. The base station controller coordinates the operation of the base station transceivers.

Each transceiver includes a RF transmitter and a RF receiver. The RF transmitter converts forward link call data into a RF signal which is transmitted to the mobile telephone. The RF transmitter may include audio processor(s), modulator(s), and power amplifier(s). The audio processor converts the forward link call audio data into a digital signal. The modulator encodes the digital signal into phase shifts of the carrier frequency. The PA (Power Amplifier) amplifies the signal before it is transmitted to the mobile telephone.

The RF receiver converts the received RF signal from the mobile telephone into reverse link call data. The RF receiver may include PAs, demodulators, and audio processors. The PA amplifies the received low level signals. The demodulator transforms the phase shift of the received signal back into digital form. The audio processors convert the digital signal into an audio signal for transmission to the mobile service switching center.

Specifically, a beacon transmitter is added to the base station RF transceiver. The beacon transmitter may require the addition of a separate PA. There are four types of coded channel signals that are being broadcast from a base station—pilot, sync, paging, and traffic. The pilot channel signal provides the mobile telephone with a beacon, timing and phase reference for coherence detection as well as signal strength information for power control. The pilot channel signal is a continuously repeated simple spread signal at high power levels which allows mobile telephones to locate the cell site (base station). The pilot signal is normally the strongest signal that is transmitted from the cell and always uses Walsh code 0. Walsh coding is orthogonal coding, i.e. a system of spreading codes that have no relationship to each other.

FIG. 1 is a block diagram of a conventional digital transceiver setup, in which dotted lines generally indicate flow of data, while solid lines generally represent transmission of control signals. Referring to FIG. 1, a link FPGA (Field Programmable Gate Array) 10 performs time division on transmission data sent from a channel card. Particularly, the transmission data is being divided into data units with each unit having a frequency assignment (FA). A combiner with CFR (Crest Factor Reduction) 20 receives the time-divided data from link FPGA 10 and performs clean-up filtering on the same to reduce interference from neighboring channels. Subsequently, combiner with CFR 20 determines the frequency location of each data unit by multiplying the same by a NCO (Numerical Control Oscillator) value.

The combined data is input to a digital pre-distorter 30 to enhance the linearity of an associated PA. Pre-distortion is a linearization technique (functionality) that is typically incorporated into PAs and transmitters to improve output linearity and allow operation with less back-off, and therefore higher efficiency. Pre-distortion generally involves the insertion of a nonlinear element prior to the RF PA such that the combined transfer characteristic of both is substantially linear. Pre-distortion may be accomplished at either RF or baseband.

The pre-distorted data is input to a double rate quadrature demodulator FPGA 40 which rearranges the input data to synchronize the same. The synchronized data is delivered to a RF transmitter 50 which includes DAC (Digital-to-Analog Conversion) and frequency upconverter functionality. A RF receiver 60 processes analog audio data via an ADC (Analog-to-digital converter) and a frequency downcoverter. The processed data is a quantized IF (Intermediate Frequency) signal which is input to double rate quadrature demodulator FPGA 40.

FPGA 40 doubly samples the quantized IF signal inputted and transfers the sampled signal to digital pre-distorter 30. The operation of link FPGA 10, combiner with CFR 20, digital pre-distorter 30, and double rate quadrature demodulator FPGA 40 is coordinated by a DSP (Digital Signal Processor) and controller module 70 (FIG. 1).

FIG. 2 is a block diagram of a conventional beacon transmitter setup, in which dotted lines generally indicate flow of data, while solid lines generally represent transmission of control signals. This type of setup may be used in a CDMA system. The beacon transmitter may be separately added to a CDMA base station RF transceiver.

Referring to FIG. 2, signal generators 80, 90, and 100 are implemented by a FPGA. A DAC 81 converts a digital signal generated from signal generator 80 into analog form. The converted analog signal passes through an equalizer 82 a modulator 83, and an amplifier 84. The amplified signal (α-sector output) is transmitted via RF antenna to a mobile telephone in the coverage area. Similar outputs are generated for transmission to RF antennas for sectors β and γ, respectively.

Transmitting beacon and user data signals using the above-described digital transceiver and beacon transmitter setups may lead to problems. Both signals share the power amplifier, whereby the beacon signal is fed back to digital pre-distorter 30, thereby inevitably causing interference thereto. Hence, the performance of digital pre-distorter 3 may be degraded.

The beacon transmitter functionality provided to the base station may be removed to solve the interference problem. However, the corresponding handoff is performed utilizing only basic handoff functionality of the base station, in which case the call access rate is considerably reduced.

### SUMMARY OF THE INVENTION

In accordance with one aspect of the present invention, a method for enhancing the call access rate in a communication system comprises generating a pilot signal from a FPGA (Field Programmable Gate Array) integrated with a multi-carrier digital transceiver, producing a phase-equalized beacon signal from the generated pilot signal, and multiplying the phase-equalized beacon signal by a predetermined oscillation frequency generated by a NCO (Numerical Control Oscillator). The NCO produces an output signal which is summed up with a pre-distorted user data output signal. The summed up signal is rearranged for synchronization and power amplification. The amplified signal includes the beacon signal.

The method also comprises delivering a quantized IF (Intermediate Frequency) signal to a notch filter with the quantized IF signal including the beacon signal, and using the notch filter to remove the beacon signal from the quantized IF signal. The notch filter uses delay time information provided by a DSP (Digital Signal Processor) and controller module. The notch filter removes the beacon signal at the frequency position determined by the delay information. The DSP and controller module measures the delay time together with a coefficient of the notch filter. The NCO and the notch filter are included in the integrated FPGA.

In accordance with another aspect of the present invention, a method for enhancing the call access rate in a communication system comprises integrating a FPGA with a multi-carrier digital transceiver. The integrated FPGA is adapted to perform double rate quadrature demodulation, beacon signal generation and notch filtering. The method also comprises using the integrated FPGA to generate a beacon signal, passing the generated beacon signal through a pulse shaping filter, passing the pulse-shaped beacon signal through a phase equalizer filter, and hopping the pulse-shaped beacon signal to a frequency position of a predetermined offset from a defined center frequency.

In accordance with yet another aspect of the present invention, a method for enhancing the call access rate in a communication system comprises performing time division on a user data signal, passing the time-divided user data signal through a combiner with CFR (Crest Factor Reduction), delivering the combined output signal to a digital pre-distorter to enhance the linearity of an associated power amplifier, and sending pre-distorted data to a FPGA integrated with a multi-carrier digital transceiver. The integrated FPGA is adapted to perform double rate quadrature demodulation, beacon signal generation and notch filtering on said pre-distorted data.

In accordance with still another aspect of the present invention, an apparatus for enhancing the call access rate in a communication system comprises a first FPGA (Field Programmable Gate Array) adapted to perform time division on a user data signal, means for filtering the time-divided user data signal to reduce interference from neighboring channels, a digital pre-distorter adapted to process the filtered user data, and a second FPGA adapted to perform double rate quadrature demodulation, beacon signal generation and notch filtering on the pre-distorted data.

The apparatus also comprises a DSP (Digital Signal Processor) and controller module which coordinates the operation of the digital pre-distorter and the first and second FPGAs. The filtering means includes a combiner with CFR (Crest Factor Reduction). The DSP and controller module also coordinates the operation of the combiner with CFR.

The second FPGA is integrated with a multi-carrier digital transceiver. The integrated FPGA is operatively coupled to at least one RF (Radio Frequency) transmitter and at least one RF receiver. The integrated FPGA comprises at least one signal generator, at least one phase equalizer filter, and at least one pulse shaping filter operatively coupled between the signal generator and the phase equalizer filter. The signal generator is adapted to generate a pilot signal. The pilot signal is passed through the pulse shaping filter to produce a beacon signal having a predetermined frequency bandwidth.

The integrated FPGA further comprises at least one NCO (Numerical Control Oscillator) operatively coupled to the phase equalizer filter, and at least one notch filter adapted to remove the beacon signal from a quantized IF (Intermediate Frequency) input signal.

These and other aspects of the present invention will become apparent from a review of the accompanying drawings and the following detailed description of the present invention.

### BRIEF DESCRIPTION OF THE DRAWINGS

The present invention is generally shown by way of reference to the accompanying drawings as follows.

FIG. 1 is a block diagram of a conventional digital transceiver setup.

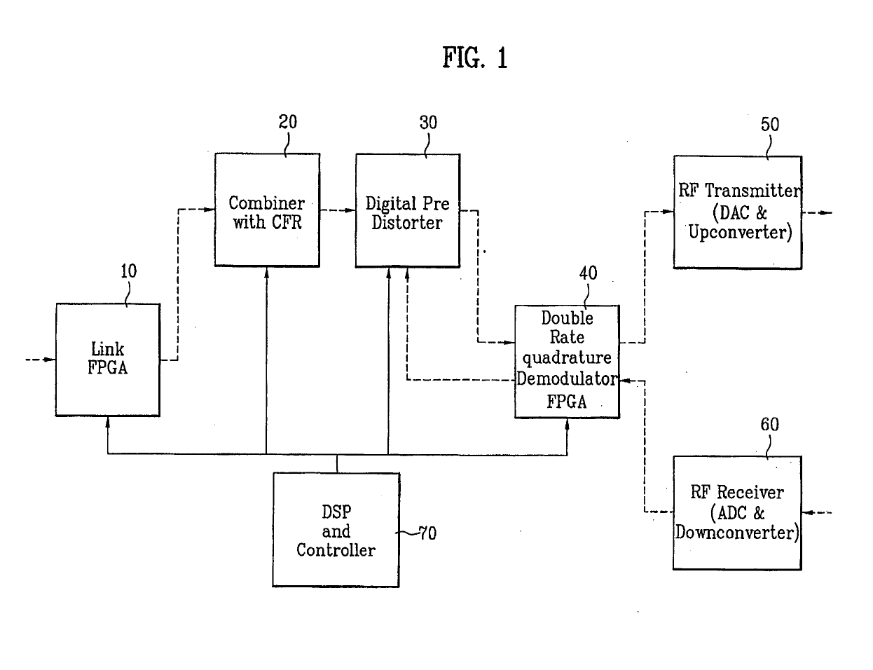

FIG. 2 is a block diagram of a conventional beacon transmitter setup.

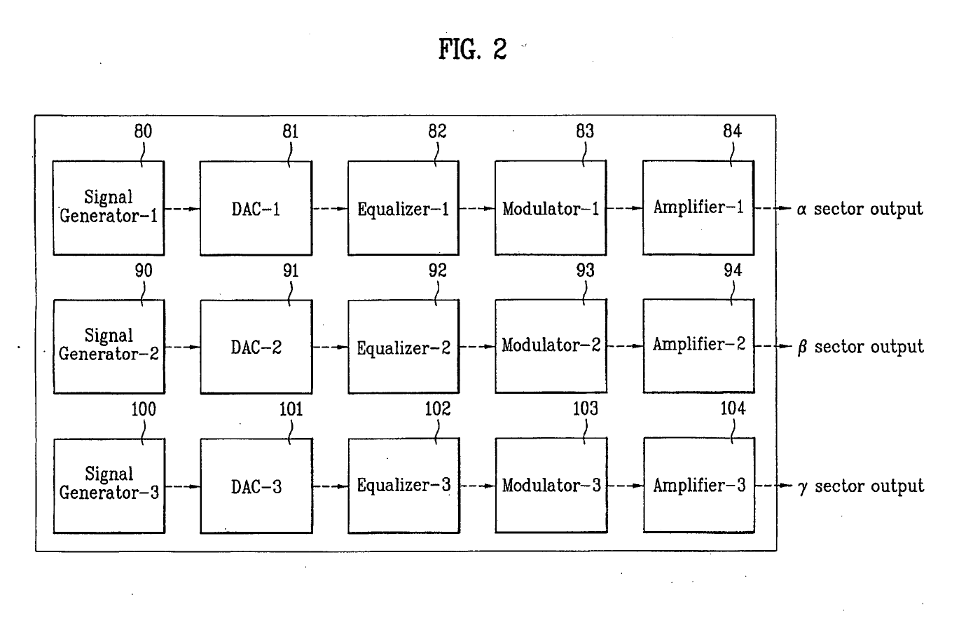

FIG. 3 is a block diagram of a digital transceiver setup in accordance with one embodiment of the present invention.

FIG. 4 is a block diagram of an integrated FPGA in accordance with another embodiment of the present invention.

FIG. 5 is a schematic representation of signal spectra in accordance with yet another embodiment of the present invention.

### DETAILED DESCRIPTION OF THE PREFERRED EMBODIMENTS

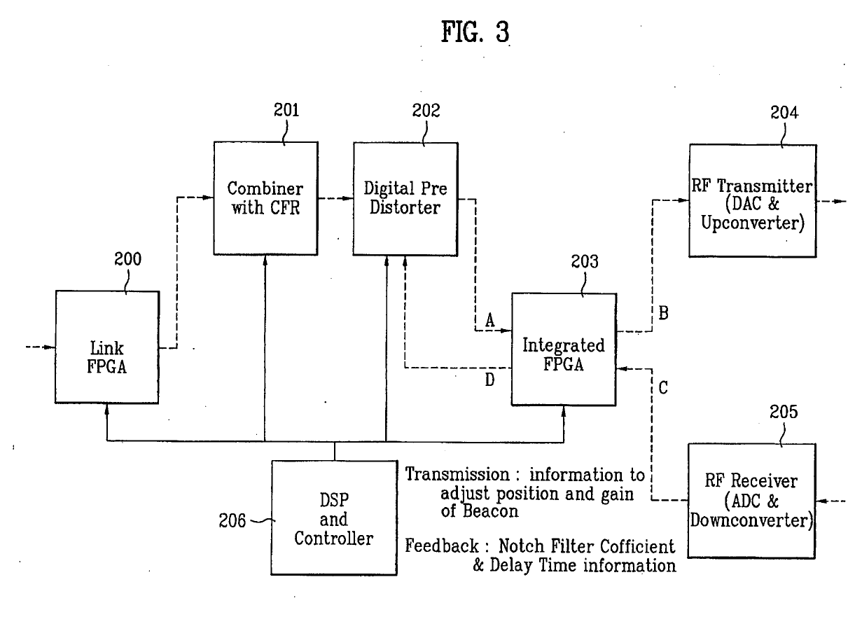

Some embodiments of the present invention will be described in detail with reference to the related drawings of FIGS. 3-5. Additional embodiments, features and/or advantages of the invention will become apparent from the ensuing description or may be learned by practicing the invention.

In the figures, the drawings are not to scale with like numerals referring to like features throughout both the drawings and the description.

The following description includes the best mode presently contemplated for carrying out the invention. This description is not to be taken in a limiting sense, but is made merely for the purpose of describing the general principles of the invention.

FIGS. 3-5 generally depict a method and apparatus for enhancing the call access rate in a communication system in accordance with the general principles of the present invention. FIG. 3 is a block diagram of a multi-carrier digital transceiver setup in accordance with one embodiment of the present invention. Specifically, a link FPGA 200 performs time division on a user data signal transmitted from a channel card. The transmitted data is divided into data units with each unit having a frequency assignment (FA).

A combiner with CFR (Crest Factor Reduction) 201 receives the time-divided data from link FPGA 200 and performs filtering on the same to reduce interference from neighboring channels. Subsequently, combiner with CFR 201 determines the frequency location of each data unit by multiplying the same by a NCO (Numerical Control Oscillator) value.

The combined data is input to a digital pre-distorter 202 to enhance the linearity of an associated PA. The pre-distorted data is sent to an integrated FPGA 203 which performs double rate quadrature demodulation, beacon signal generation, and notch filtering on the same.

Integrated FPGA 203 generates a beacon signal and combines the generated beacon signal with the input user data signal so that the generated beacon signal has a predetermined offset to the user data signal. Particularly, the beacon signal is combined with the frequency position having a predetermined offset to a center frequency. Integrated FPGA 203 performs double rate quadrature demodulation to synchronize the rearranged signal.

The synchronized data is delivered to a RF transmitter 204 which includes DAC and frequency upconverter functionality. A RF receiver 205 processes analog audio data via an ADC (Analog-to-digital converter) and a frequency downcoverter. The processed data is a quantized IF (Intermediate Frequency) signal which is input to integrated FPGA 203. FPGA 203 uses double rate quadrature demodulation to sample the quantized IF signal and transfers the doubly sampled signal to digital pre-distorter 202. Integrated FPGA 203 also performs notch filtering to remove the beacon signal from the inputted signal.

Digital pre-distorter 202 compares the signal that was inputted from integrated FPGA 203 to the signal inputted from combiner with CFR 201. In doing so, the beacon signal is removed from the two compared signals.

The operation of link FPGA 200, combiner with CFR 201, digital pre-distorter 202, and integrated FPGA 203 is coordinated by a DSP and controller module 206 (FIG. 3). Specifically, DSP and controller module 206 provides frequency position and gain adjustment information on the beacon signal. In doing so, the beacon signal is combined with the user data signal inputted from integrated FPGA 203. Module 206 also provides a filtering coefficient of the notch filter provided to integrated FPGA 203 and delay time information on the beacon signal included in the feedback signal.

Accordingly, the frequency position and gain adjustment information of the beacon signal combined with a signal to be transmitted are already known to integrated FPGA 203. Hence, integrated FPGA 203 performs frequency hopping on the generated beacon signal to an appropriate frequency position. Thus, the beacon signal is not available for processing by combiner with CFR 201 and digital pre-distorter 202 of the present invention.

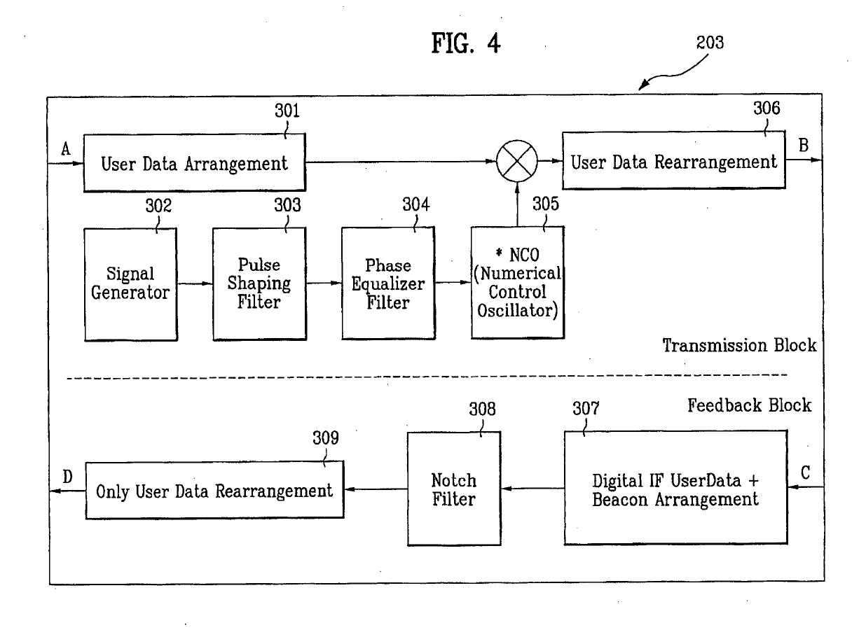

FIG. 4 is a block diagram of the operation of integrated FPGA 203 in accordance with another embodiment of the present invention. A signal generator 302 generates a CDMA signal, and more particularly, a pilot signal. The pilot signal is passed through a pulse shaping filter 303 which outputs a beacon signal having a predetermined frequency bandwidth. For instance, pulse shaping filter 303 may be adapted to output a beacon signal having 1.23 MHz bandwidth.

A phase equalizer filter 304 processes the input beacon signal to reduce interference from neighboring channels. The phase-equalized beacon signal is multiplied by a predetermined oscillation frequency generated from a NCO (Numerical Control Oscillator) 305 so that the beacon signal hops to a frequency position of a predetermined offset from a center frequency.

Thereafter, a user data output signal from a user data arrangement module 301, is summed up with the frequency-position determined beacon signal, i.e., the output of NCO 305, as generally depicted in FIG. 4. The output signal from user data arrangement module 301 is essentially the output of digital pre-distorter 202 of FIG. 3. The summed signal is rearranged for synchronization acquisition by user data rearrangement module 306 and is subsequently passed through a PA before being transmitted to a mobile telephone in the area covered by the base station.

Thus, the beacon signal is only included in the signal that is passed through the PA. The beacon signal does not affect the functionality of digital pre-distorter 202 of FIG. 3.

A digital IF user data & beacon signal arrangement module 307 delivers a quantized IF signal to a notch filter 308. The user data signal and beacon signal are included in the quantized IF signal. Notch filter 308 removes the beacon signal from the quantized IF signal. In doing so, notch filter 308 uses the delay time information provided by DSP and controller module 206 of FIG. 3. Accordingly, notch filter 308 filters the beacon signal at the frequency position determined by the delay time information provided by DSP and controller module 206. The delay time of the IF signal entering the feedback path is known to DSP and controller module 206 of FIG. 3.

The DSP and controller module 206 measures the delay time to provide the delay time of the IF signal inputted from notch filter 308 together with a coefficient of notch filter 308. Notch filter 308 then filters the beacon signal at the corresponding frequency position after the provided delay time has passed. The filtered signal is delivered to a user data only rearrangement module 309 (FIG. 4). The coefficient of notch filter 308 may be implemented using MATLAB®) or other suitable computational tools. The skirt characteristic of notch filter 308 is adjusted in accordance with performance of digital pre-distorter 202.

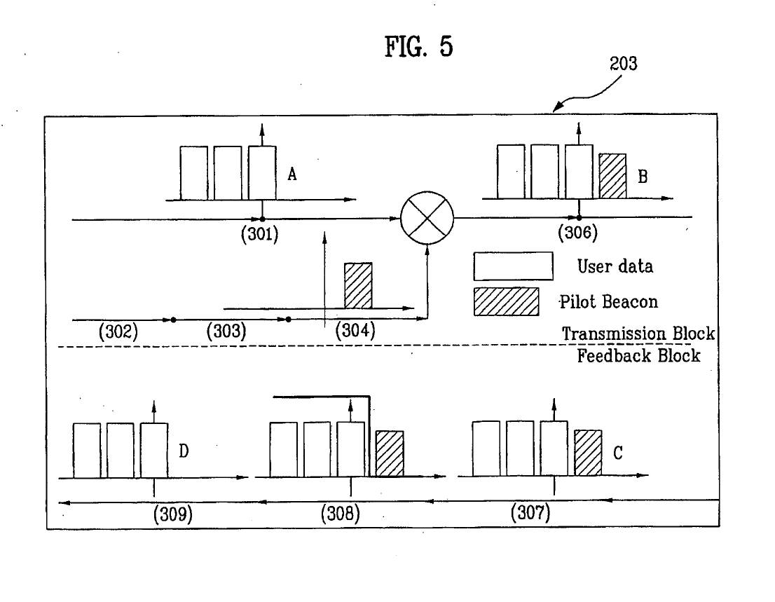

FIG. 5 is a schematic representation of signal spectra generated by the various integrated FPGA components of FIG. 4. Specifically, notch filter 308 filters the beacon signal from the fed-back reception signal. In doing so, the frequency position of the beacon signal included in the fed-back signal is determined based on the frequency position information and/or delay time information of the beacon signal provided by DSP and controller module 206 (FiIG. 3). Hence, notch filter 308 (FIGS. 4-5) removes the fed-back signal at the accurate frequency position. Digital pre-distorter 202 compares the feedback signal (with the beacon signal having been removed by notch filter 308) to the user data signal to be transmitted to enhance the linearity of the PA. Hence, the beacon signal included in the fed-back reception signal cannot generate interference, which is particularly beneficial in hard handoffs. The filtered beacon signal helps prevent performance degradation of digital pre-distorter 102.

Moreover, there is no need to purchase and attach a separate beacon transmitter card to the digital transceiver of the base station. Using the integrated FPGA of the present invention prevents degradation of the base station performance and enhances the call access rate.

All terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

While the present invention has been described in detail with regards to several embodiments, it should be appreciated that various modifications and variations may be made in the present invention without departing from the scope or spirit of the invention. In this regard it is important to note that practicing the invention is not limited to the applications described hereinabove.

Many other applications and/or alterations may be utilized provided that such other applications and/or alterations do not deviate from the intended purpose of the present invention. Also, features illustrated or described as part of one embodiment can be used in another embodiment to provide yet another embodiment such that the features are not limited to the embodiments described above. Thus, it is intended that the present invention cover all such embodiments and variations as long as such embodiments and variations come within the scope of the appended claims and their equivalents.

1. A method for enhancing the call access rate in a communication system, comprising the steps of:
generating a pilot signal from a FPGA (Field Programmable Gate Array) integrated with a multi-carrier digital transceiver;
producing a phase-equalized beacon signal from said generated pilot signal;
multiplying said phase-equalized beacon signal by a predetermined oscillation frequency generated by a NCO (Numerical Control Oscillator), said NCO producing an output signal;
summing up said NCO output signal with a pre-distorted user data output signal;
rearranging said summed up signal for synchronization and power amplification, said amplified signal including said beacon signal;
delivering a quantized IF (Intermediate Frequency) signal to a notch filter, said quantized IF signal including said beacon signal; and
using said notch filter to remove said beacon signal from said quantized IF signal.

2. The method of claim 1, wherein said notch filter uses delay time information provided by a DSP (Digital Signal Processor) and controller module.

3. The method of claim 2, wherein said notch filter removes said beacon signal at the frequency position determined by said delay information.

4. The method of claim 3, wherein said DSP and controller module measures said delay time together with a coefficient of said notch filter.

5. The method claim 1, wherein said NCO and said notch filter are included in said integrated FPGA.

6. A method for enhancing the call access rate in a communication system, comprising the steps of:
integrating a FPGA (Field Programmable Gate Array) with a multi-carrier digital transceiver, said integrated FPGA adapted to perform double rate quadrature demodulation, beacon signal generation and notch filtering;
using said integrated FPGA to generate a beacon signal;
passing said generated beacon signal through a pulse shaping filter;
passing said pulse-shaped beacon signal through a phase equalizer filter; and
hopping said pulse-shaped beacon signal to a frequency position of a predetermined offset from a defined center frequency.

7. A method for enhancing the call access rate in a communication system, comprising the steps of:
performing time division on a user data signal;
passing said time-divided user data signal through a combiner with CFR (Crest Factor Reduction), said combiner with CFR producing an output signal;
delivering said combined output signal to a digital pre-distorter to enhance the linearity of an associated power amplifier; and
sending pre-distorted data to a FPGA (Field Programmable Gate Array) integrated with a multi-carrier digital transceiver, said integrated FPGA adapted to perform double rate quadrature demodulation, beacon signal generation and notch filtering on said pre-distorted data.

8. An apparatus for enhancing the call access rate in a communication system, comprising:
a first FPGA (Field Programmable Gate Array) adapted to perform time division on a user data signal;
means for filtering said time-divided user data signal to reduce interference from neighboring channels;
a digital pre-distorter adapted to process said filtered user data; and
a second FPGA adapted to perform double rate quadrature demodulation, beacon signal generation and notch filtering on said pre-distorted data.

9. The apparatus of claim 8, further comprising a DSP (Digital Signal Processor) and controller module adapted to coordinate the operation of said digital pre-distorter and said first and second FPGAs.

10. The apparatus of claim 9, wherein said filtering means includes a combiner with CFR (Crest Factor Reduction).

11. The apparatus of claim 10, wherein said DSP and controller module is adapted to coordinate the operation of said combiner with CFR.

12. The apparatus of claim 11, wherein said second FPGA is integrated with a multi-carrier digital transceiver.

13. The apparatus of claim 12, wherein said integrated FPGA is operatively coupled to at least one RF (Radio Frequency) transmitter and at least one RF receiver.

14. The apparatus of claim 13, wherein said integrated FPGA comprises at least one signal generator, at least one phase equalizer filter, and at least one pulse shaping filter operatively coupled between said at least one signal generator and said at least one phase equalizer filter, said at least one signal generator adapted to generate a pilot signal, said pilot signal being passed through said at least one pulse shaping filter to produce a beacon signal having a predetermined frequency bandwidth.

15. The apparatus of claim 14, wherein said integrated FPGA further comprises at least one NCO (Numerical Control Oscillator) operatively coupled to said at least one phase equalizer filter.

16. The apparatus of claim 15, wherein said integrated FPGA further comprises at least one notch filter adapted to remove said beacon signal from a quantized IF (Intermediate Frequency) input signal.
